(19) United States
(12) Patent Application Publication
(10) Pub. No.: US 2020/0013106 A1
(43) Pub. Date: Jan. 9, 2020

(54) SYSTEM FOR DETERMINING PREFERENCES BASED ON PAST DATA

(71) Applicant: VISA INTERNATIONAL SERVICE ASSOCIATION, San Francisco, CA (US)

(72) Inventors: Nikan Chavoshi, Palo Alto, CA (US); Dean Galland, Palo Alto, CA (US); Di You, Foster City, CA (US)

(21) Appl. No.: 16/484,355

(22) PCT Filed: Feb. 10, 2017
(86) PCT No.: PCT/US17/17357

§ 371 Date: Aug. 7, 2019

(51) Int. Cl. G06Q 30/06; G06N 5/04

(52) U.S. Cl. CPC G06Q 30/0631; G06N 20/00; G06N 5/04

(57) ABSTRACT

A computer based system and method are disclosed which are configured for determining preferences to known merchants based on past purchase data using word vectors.

### BACKGROUND

Consumers often need guidance when purchasing new products or services. The need could be based on a desire to try something new or may be based on arriving in a new city or having a need at a new time. Guides may be helpful but guides are not localized to an individual user. In addition, users generate a significant amount of data about past purchases but trying to determine future merchants that may be related to an existing merchant is a challenge that has not been met by existing technology.

### SUMMARY

A computer based system and method are disclosed which are configured for determining preferences to known merchants based on past purchase data using word vectors. The system and method may select a user of an electronic commerce payment device from a payment server and determine word vectors for previous merchants that the user has already used. Attributes of the previous merchants may be determined from a semantic extraction algorithm subject to a correlation threshold which determines the semantic to be reviewed. A plurality of merchants may be selected which may be reviewed as recommended merchants. Word vectors may be determined for the recommended merchants using the word vector server and a correlation of attributes from previous merchants to recommended merchants may be determined. Threshold merchants may be determined where threshold merchants have a determined correlation value above a threshold. In response to threshold merchants being determined, a correlation of dimension index sets may be calculated for the merchant and the threshold merchants. A list of threshold merchants and highest ranked attribute may be provided to the user as justification for the selection of merchants.

### BRIEF DESCRIPTION OF THE DRAWINGS

FIG. 1 is an illustration of a system in accordance with the claims for determining preferences to known merchants based on past purchase data using word vectors;

FIG. 2 is an illustration of the method of determining preferences to known merchants based on past purchase data using word vectors;

FIG. 3 may be a sample user interface where a user may request a recommendation;

FIG. 4 may be a sample user interface where an authority may adjust the threshold;

FIG. 5 may illustrate a user interface where a number of recommendations may be set;

FIG. 6 may illustrate the ability of a user to select attributes of importance;

FIG. 7 may be a sample user interface listing the threshold merchants and justifications based on the attributes;

FIG. 8 may be an illustration of a portable computer system and a server computer system;

FIG. 9 may be an illustration of a portable computing system; and

FIG. 10 may be an illustration of a sample server computing system with a database.

### SPECIFICATION

Consumers often need guidance when purchasing new products or services. The need could be based on a desire to try something new or may be based on arriving in a new city or having a need at a new time. Guides may be helpful but guides are not localized to an individual user. In addition, users generate a significant amount of data about past purchases but trying to determine future merchants that may be related to an existing merchant is a challenge that has not been met by existing technology.

A computer based system and method are disclosed which are configured for determining preferences to known merchants based on past purchase data using word vectors. The system and method may select a user of an electronic commerce payment device from a payment server and determine word vectors for previous merchants that the user has already used. Attributes of the previous merchants may be determined from a semantic extraction algorithm subject to a correlation threshold which determines the semantic to be reviewed. A plurality of merchants may be selected which may be reviewed as recommended merchants. Word vectors may be determined for the recommended merchants using the word vector server and a correlation of attributes from previous merchants to recommended merchants may be determined. Threshold merchants may be determined where threshold merchants have a determined correlation value above a threshold. In response to threshold merchants being determined, a correlation of dimension index sets may be calculated for the merchant and the threshold merchants. A list of threshold merchants and highest ranked attribute may be provided to the user as justification for the selection of merchants.

As a result, many technical problems are addressed. The ability to match new merchants to previously used merchants has been a challenge. By using advanced computer based learning techniques, the attributes of merchants may be converted into word vectors which may make the comparison of previous merchants and new merchants significantly more accurate. Further, the computer based techniques may also allow for the matching attributes to be disclosed to the user which will result in less searching and more confidence in the system.

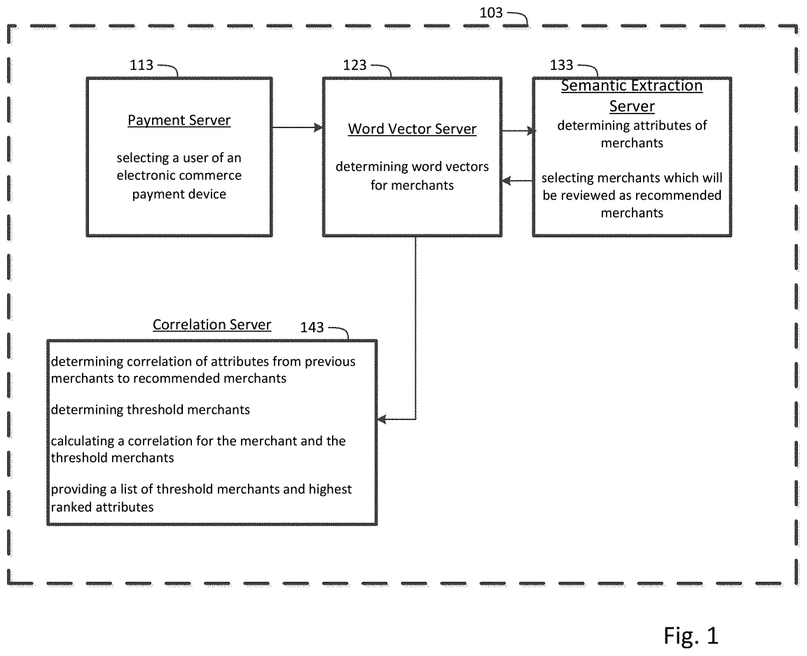

FIG. 1 may illustrate a computer system for determining preferences to known merchants based on past purchase data using word vectors. The system 103 may have a plurality of servers such as a payment server 113, a word vector server 123, a semantic extraction server 133 and a correlation server 143. The servers 113-143 may be separate servers that are physically configured to perform the specific task. In other embodiments, the servers may exist in a single server which may have one or more processors that is physically configured to execute the designated task. In yet another embodiment, the servers may be in a cloud and the physical configuration may change based on need, load, time of day, etc.

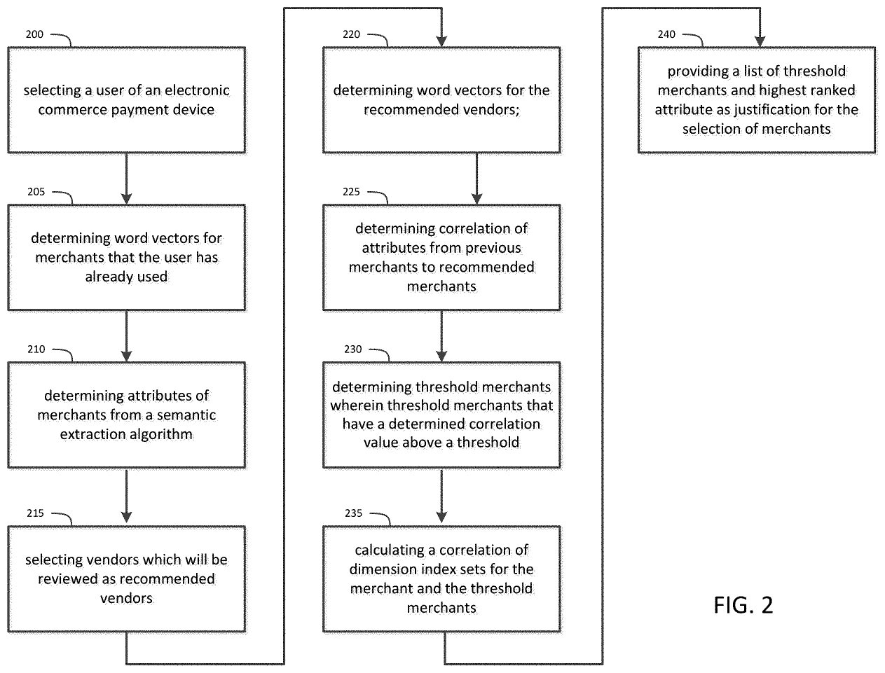

FIG. 2 may illustrate a method of determining preferences to known merchants based on past purchase data using word vectors that may operate on the system. The blocks of the method may be spread among the various servers 113-143 where the servers are physically configured to execute the blocks.

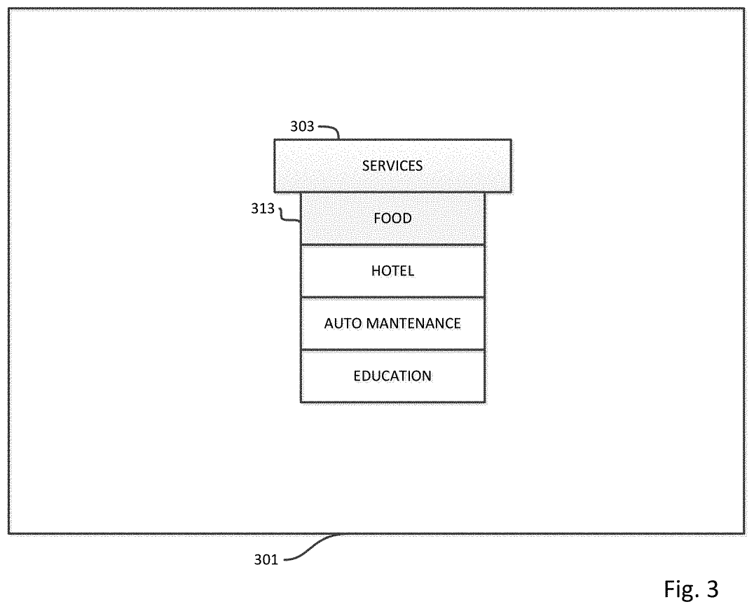

FIG. 3 may be a sample user interface 301 where a user may request a recommendation. The user may select a service 303 and a possible service type 313 for the recommendation. The service type may be used to focus the analysis by the system 103 to provide the desired type of recommendation. For example, users looking for food would not want recommendations for furniture stores.

In the payment server 113, a payment server may be physically configured for selecting a user of an electronic commerce payment device as described in block 200 of FIG. 2. A payment server 113 may contain data on past purchases of a buyer, including the goods or services and the merchant. In some embodiments, the payment server 113 may also include data on the location of the merchant, the cost of the goods or services and details on the goods or services such as color, size, shape, etc. The past purchase data in the payment server 113 may be useful to find new merchants that are similar in some determined way to the merchants previously supported.

The payment server 113 may have data on one type of payment device or a plurality of payment devices. For example, the payment device may be a credit card and the payment server 113 may contain data on the specific credit card. In another embodiment, the payment server 113 may contain data on a plurality of payment devices such as a plurality of credit cards, a plurality of debit cards, bank accounts, travel point sites, bonus points, etc.

The merchant data may be communicated to a word vector server 123 at block 205 which may be physically configured for determining word vectors for merchants that the user has already used. In some embodiments, an algorithm may be used to translate the merchant data into word vectors. Algorithms to translate words or data into word vectors may be known. As an example, GloVe, TensorFlow or Word2vec may be used to translate the merchant data into vectors. The purpose of translating the merchant data into vectors is that it may be easier, faster, efficient and require less processor power to locate similar vectors from a currently used merchant to a prospective merchant. The word vector server 205 may be physically configured to efficiently and quickly convert merchant data into vectors and dimensional indexes and to store the vectors and dimensional indexes for future use.

The word vector server 123 may communicate the determined word vectors and related dimensional index to a semantic extraction server as described in block 210. The vector server may be physically configured to determine attributes of merchants from a semantic extraction algorithm. The attributes and related dimensional index may be subject to a correlation threshold which determines the semantic set to be reviewed. In some embodiments, the correlation threshold is set by an authority such as a computer administrator. In another embodiment, past correlations are used to set the threshold. In yet another embodiment, yet another algorithm adjusts the threshold to produce the desired number of results.

At block 215, merchants may be selected which will be reviewed as recommended merchants. The selection may occur in a variety of ways. In some embodiment, a cursory review of similarities between the previous merchants and the prospective merchants may be made by an algorithm. For example, if the past merchants and prospective merchants have similar attributes, the prospective merchant may be included for additional review. In another embodiment, merchants may be selected which have been determined to be related to past merchants previously. In yet another embodiment, merchants may be selected if they have requested to be included as recommended merchants and there are a minimum amount of similar attributes.

At block 220, the word vector server 123 may receive the recommended merchants from the semantic extraction server 133. As noted previously, the word vector server 123 may be physically configured for determining word vectors from inputted data, such as the recommended merchants. Also as noted previously, a word vector algorithm may be executed against the recommended merchants.

At block 225, the word vectors and dimensional index for the possible recommended merchants may be communicated to the correlation server 143. The correlation server 143 may be physically configured for determining correlation of attributes from previous merchants to recommended merchants. The correlation may be accomplished in a variety of ways. In one embodiment, a Pearson correlation may be used but more sophisticated correlation algorithms and methods may be used.

At block 230, threshold merchants may be determined where threshold merchants that have a determined correlation value above a threshold. If the correlation is above a threshold 408, the concept is that the threshold merchants have enough common vectors with existing merchants that the new threshold and existing merchants may be sufficiently close. The threshold may be set in a variety of ways. In one embodiment, the threshold is set by an administrator or authority. In another embodiment, past thresholds may be used. In yet another embodiment, a threshold algorithm may be used to determine the proper threshold needed to obtain a desired number of threshold merchants. Of course, other manners of setting the threshold are possible and are contemplated.

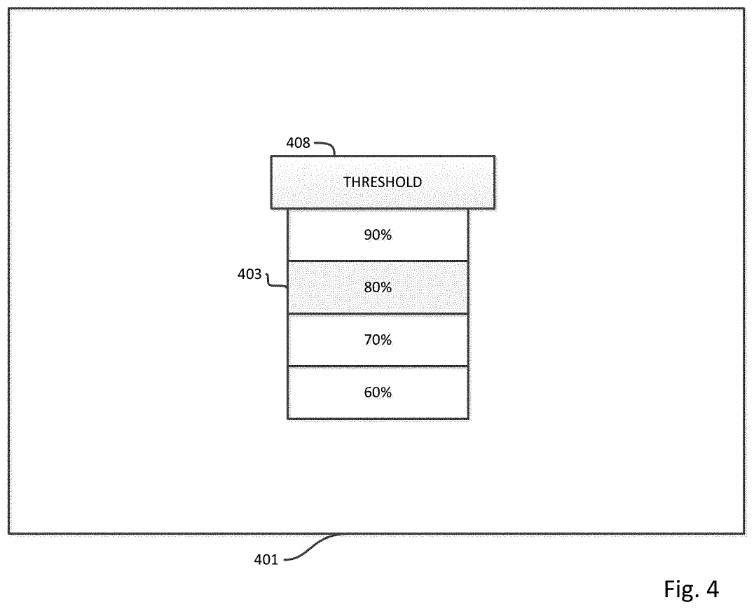

FIG. 4 may be a sample user interface 401 where an authority may adjust the threshold 408. If the authority desired the correlation to be 80%, then the authority may select the 80% box 403. Of course, the threshold may be any number between 1-100.

At block 235, in response to determining threshold merchants, a correlation of dimension index sets for the merchant and the threshold merchants may be determined. The correlation may be determined in a variety of ways such as using a correlation algorithm such as the Pearson algorithm or even more complex algorithms.

At block 240, a list of threshold merchants may be provided to the user. In addition, a highest ranked attribute may be provided to the user as justification for the selection of merchants. For example, if the availability of mac and cheese is determined to be an important attribute, this attribute may be listed along with the threshold merchants. The highest ranked attributes may be conveyed to the user in a narrative using a narrative algorithm. For example, the narrative may be something like “Merchant A was recommended as a restaurant because Merchant A serves mac and cheese like your favorite restaurant, Merchant B” where the underlined terms are filled in as appropriate from the analysis of the system 103.

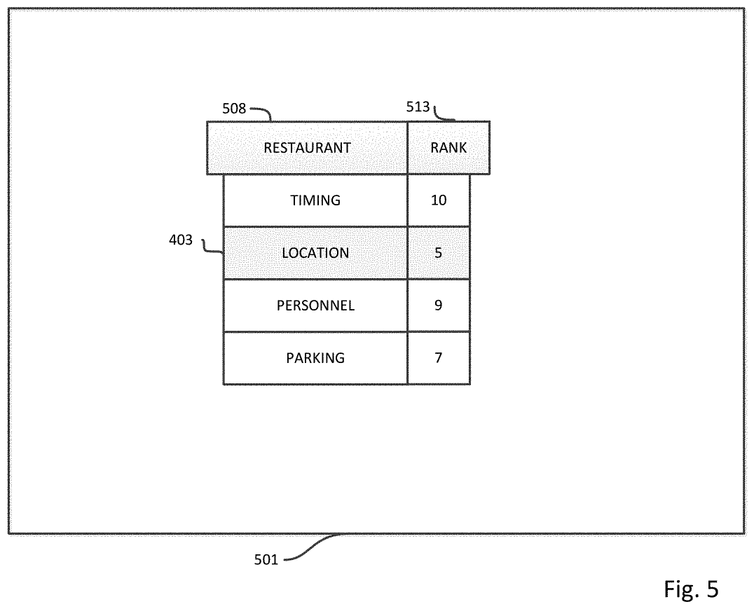

FIG. 5 may be a user interface 501 that illustrates the ability of a user to select attributes of importance 513 for the desired merchant 508. If the service is a restaurant, a user may rank that location 403 lower than quick service or timing. In this way, the user can further tailor the system to the needs at the present time.

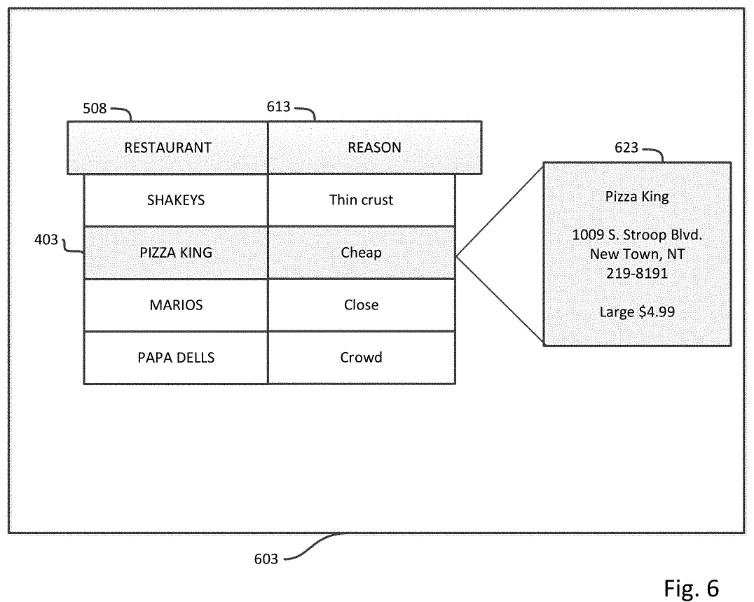

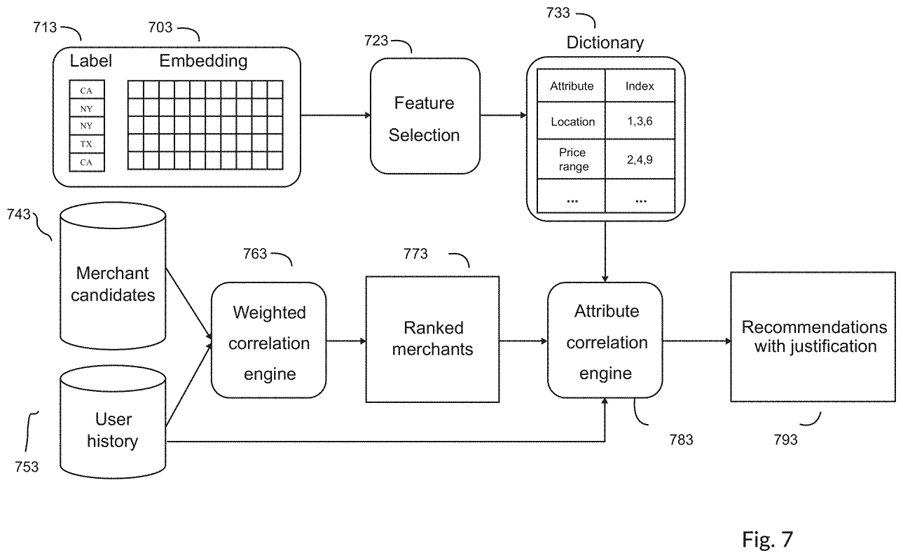

FIG. 6 may be a sample user interface 603 listing the threshold merchants 508 and justifications or reasons based on the attributes 613. In FIG. 7, Pizza King may be recommended 403 as it is cheap and Pizza King may be highlighted. The reason it is recommended may be listed. In addition, in some embodiments, other options are listed along with the reason 613 or attribute that was found to be in common with previously purchased merchants. Additional detail on the recommended merchant may be received by selecting the merchant and a popup window may disclose additional detail 623 such as an address, price list or map.

FIG. 7 may illustrate another embodiment of the system 103. At a high level, given the merchant embedding vectors 703 and labels 713, the system may use the proposed feature selection approach in a feature selection algorithm 723 operating on a feature selection server such as the word vector server 123 of FIG. 1 to build a dictionary 733 where each attribute is associated with a set of learned index of dimensions. The semantic extraction server 133 of FIG. 1 may assist in determining the relevant attributes of the merchants.

Merchant candidates 743 may include a list of merchants to recommend. A user history 753 may contain merchants where a user has made transactions during a given period of time. The history may also include how recent the transaction was made as a component of the score. For example, if the user visited merchant A later than merchant B, then the score for A should be higher than B (A has more influence than B).

Given the merchant candidates 743 and user history 753, a weighted correlation engine 763 operating on a server such as the correlation server 143 of FIG. 1 may determine weighted correlations between these two sets and provided a list of ranked merchants 773.

For example, assume merchant U1 and U2 are candidates, and merchant V1 and V2 are in a user's history, and the score of V1 and V2 are w1 and w2, let the correlation between any two vectors x and y be c(x, y), then the calculated score s1 for merchant U1 will be:

s1=w1*c(U1, V1)+w2*c(U1, V2)

Then score s2 for merchant U2 will be:

s2=w1*c(U2, V1)+w2*c(U2, V2)

Then V1 and V2 (merchant candidates) may be ranked by their individual score as ranked prospective recommended merchants 773.

Given the ranked merchant calculated 773, user history 753, and dictionary built 733, an attribute correlation engine 783 may be used to aggregate a correlation score for each attribute 733 for each recommended merchant. Specifically, suppose there are two attributes a1 and a2, for any vector X, Xₐ₁ and Xₐ₂ denote the associated dimensions of X corresponding to attribute a1 and a2. Let r be a pre-defined threshold, then

For U1, the attribute score for a1 is calculated by:

sₐ₁=w1*c(U1ₐ₁, V1ₐ₁)+w2*c(U1ₐ₁, V2ₐ₁)

If sₐ₁>r, then keep a1 in the justification.

The attribute score for a2 is calculated by:

sₐ₂=w1*c(U1ₐ₂, V1ₐ₂)+w2*c(U1ₐ₂, V2ₐ₂)

If sₐ₂>r, then keep a2 in the justification.

For U2, the attribute score for a1 is calculated by:

sₐ₁=w1*c(U2ₐ₁, V1ₐ₁)+w2*c(U2ₐ₁, V2ₐ₁)

If sₐ₁>r, then keep a1 in the justification.

The attribute score for a2 is calculated by:

sₐ₂=w1*c(U2ₐ₂, V1ₐ₂)+w2*c(U2ₐ₂, V2ₐ₂)

If sₐ₂>r, then keep a2 in the justification.

Once the recommended merchant has been determined, the output of the recommended merchants may be provided in a language template 793, such as:

“We recommended merchant V1 for you since it has the attribute a1 and/or a2.”

“We recommended merchant V2 for you since it has the attribute a1 and/or a2.”

The fields may be filled with the attributes calculated.

In pseudo computer instructions, the flow may be as follows:

Input to the system: The merchant vector u which a cardholder has already been to, the set of merchant vectors {v}ᵢ, i=1, . . . , n from which we are trying to determine the recommendation, the set of semantics (or attributes) {a}ᵢ, i=1, . . . , m and dimension index set {I}ₐᵢ, aᵢ∈a, for each attribute which are learned from the proposed semantics extraction algorithm, the correlation threshold r which is used to determine which semantics we want to output for justification.

```
    Output: The recommended merchant v and justification with
    semantics.
    1: for all vᵢ, i = 1,...,n do
    2: calculate corrᵢ = p(u, vᵢ) # calculate the correlation between
u and vᵢ using an algorithm such as a Pearson correlation algorithm
    3: end for
    4: q = argmax (corrᵢ), i=1,...,n # find the index of the maximum
    correlation
    5: for aᵢ ϵ a, I=1,..,m do
    6: calculate corrₐᵢ = p(u′, v_{q}′) # u′ and v_{q}′ indicate the dimensions
of u′ and v_{q}′ that belong to Iₐᵢ
    7: if corrₐᵢ > r, then keep aᵢ and include it in the recommendation
    justification
    8: end if
    9: end for
```

Example Data:

Input:

u=[0.3, 0.1, 0.6, 0.8],

v₁=[0.9, 0.7, 0.2, 0.1],

v₂=[0.4, 0.2, 0.7, 0.5],

Attributes:

a₁={cuisine style}, I₁={1,2},

a2={family friendly}, I₂={3,4},

r=0.7

Step 1: calculate correlation between u and all vᵢ:

Corr(u, v₁)=0.443

Corr(u, v₂)=0.944

Step 2: determine the merchant which has the maximum correlation with the given merchant u, in this case, it is merchant v₂.

Step 3: For each attribute, calculate the correlation for the associated dimensions for u and v₂.

for a₁ (cuisine style): corrₐ₁=0.99,

since 0.99>r (0.7), keep a₁

for a₂ (family friendly): corrₐ₂=0.95,

since 0.95>r (0.7), keep a₂

Step 4: Output the recommendation with justification:

An example recommendation may be as follows:

“We recommended merchant v₂ for you since you have been to merchant u before and both u and v₂ are family friendly and they have the same cuisine style.”

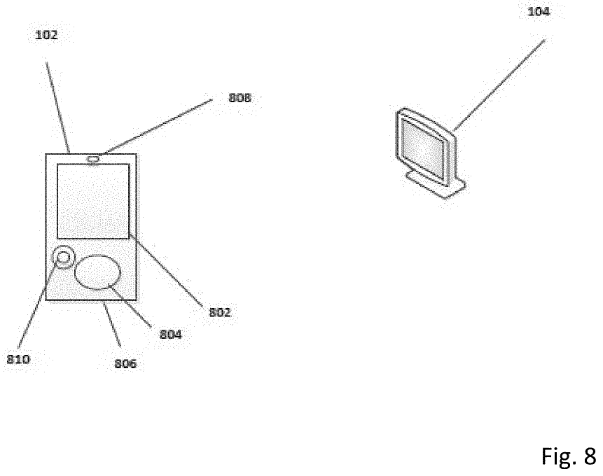

FIG. 8 may be a high level illustration of some of the elements a sample computing environment that may be physically configured to implement the various embodiments of the method and its logical variants. A user device 102 in the computing environment may store a software payment application that may be accessed in a variety of ways. There may be various versions of the application to take advantage of the benefits of different computing devices, different languages and different API platforms. In some embodiments, the entire system 103 may be accessed through a portable computing device 102 such as a smart phone and the desired activities directed toward clients may occur using a portable computing device 102.

The user device 102 may have a display 802 which may or may not be a touch sensitive display. More specifically, the display 802 may have a capacitance sensor, for example, that may be used to provide input data to the user device 102. In other embodiments, an input pad 804 such as arrows, scroll wheels, keyboards, etc., may be used to provide inputs to the user device 102. In addition, the user device 102 may have a microphone 806 which may accept and store verbal data, a camera 808 to accept images and a speaker 810 to communicate sounds.

The user device 102 may be able to communicate in a variety of ways. In some embodiments, the communication may be wired such as through an Ethernet cable, a USB cable or RJ6 cable. In other embodiments, the communication may be wireless such as through Wi-Fi (802.11 standard), Bluetooth, cellular communication or near field communication devices. The communication may be direct to the server 104 or through a wireless network, e.g., Bluetooth, etc. FIG. 7 may be a simplified illustration of the physical elements that make up a user device 102 and FIG. 8 may be a simplified illustration of the physical elements that make up the server 104.

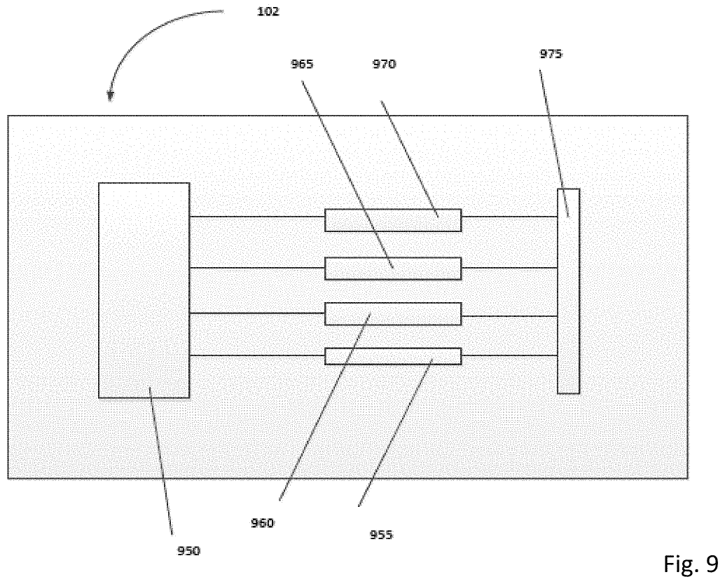

FIG. 9 may be a sample user device 102 that is physically configured according to be part of the system. The user device 102 may have a processor 950 that is physically configured according to computer executable instructions. It may have a portable power supply 955 such as a battery which may be rechargeable. It may also have a sound and video module 960 which assists in displaying video and sound and may turn off when not in use to conserve power and battery life. The user device 102 may also have volatile memory 965 and non-volatile memory 970. There also may be an input/output bus 975 that shuttles data to and from the various user input devices such as the microphone 906, the camera 908 and other inputs 902, etc. It also may control communicating with the networks, either through wireless or wired devices. Of course, this is just one embodiment of the portable computing device 102 and the number and types of portable computing devices 102 is limited only by the imagination.

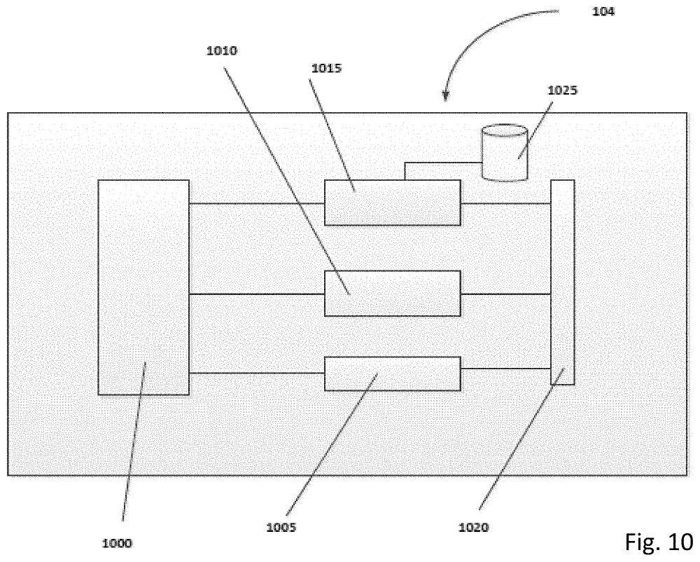

An example of the physical elements that make up a server 104 such as the payment server 113, word vector server 123, semantic extraction server 133 and correlation server 143 may be further illustrated in FIG. 10. Some of the physical elements may be located in other devices, depending on processing needs. The server 104 may have a processor 1000 that is physically configured according to computer executable instructions. It may also have a sound and video module 1005 which assists in displaying video and sound and may turn off when not in use to conserve power and battery life. The server 104 may also have volatile memory 1010 and non-volatile memory 1015. And as mentioned previously, each server may be physically built to meet the specific identified task.

In some examples, the server 104 may include digital storage such as a magnetic disk, an optical disk, flash storage, non-volatile storage, etc. Structured data may be stored in the digital storage such as in a database. A database 1025 may be stored in the memory 1010 or 1015 or may be separate. The database 1025 may also be part of a cloud and may be stored in a distributed manner. There also may be an input/output bus 1020 that shuttles data to and from the various user input devices such as the microphone 806, the camera 808, the inputs 804, etc. The input/output bus 1020 also may control communicating with the networks, either through wireless or wired devices. Of course, this is just one embodiment of the server 104 and the number and types of user devices 102 is limited only by the imagination.

In accordance with the provisions of the patent statutes and jurisprudence, exemplary configurations described above are considered to represent a preferred embodiment of the invention. However, it should be noted that the invention can be practiced otherwise than as specifically illustrated and described without departing from its spirit or scope.

The user devices, terminals, computers and servers described herein may be general purpose computers that may have, among other elements, a microprocessor (such as from the Intel Corporation, AMD or Motorola); volatile and non-volatile memory; one or more mass storage devices (i.e., a hard drive); various user input devices, such as a mouse, a keyboard, or a microphone; and a video display system. The user devices, terminals, computers and servers described herein may be running on any one of many operating systems including, but not limited to WINDOWS, UNIX, LINUX, MAC OS, or Windows (XP, VISTA, etc.). It is contemplated, however, that any suitable operating system may be used for the present invention. The servers may be a cluster of web servers, which may each be LINUX based and supported by a load balancer that decides which of the cluster of web servers should process a request based upon the current request-load of the available server(s).

The user devices, terminals, computers and servers described herein may communicate via networks, including the Internet, WAN, LAN, Wi-Fi, other computer networks (now known or invented in the future), and/or any combination of the foregoing. It should be understood by those of ordinary skill in the art having the present specification, drawings, and claims before them that networks may connect the various components over any combination of wired and wireless conduits, including copper, fiber optic, microwaves, and other forms of radio frequency, electrical and/or optical communication techniques. It should also be understood that any network may be connected to any other network in a different manner. The interconnections between computers and servers in system are examples. Any device described herein may communicate with any other device via one or more networks.

The example embodiments may include additional devices and networks beyond those shown. Further, the functionality described as being performed by one device may be distributed and performed by two or more devices. Multiple devices may also be combined into a single device, which may perform the functionality of the combined devices.

The various participants and elements described herein may operate one or more computer apparatuses to facilitate the functions described herein. Any of the elements in the above-described Figures, including any servers, terminals, user devices, or databases, may use any suitable number of subsystems to facilitate the functions described herein.

Any of the software components or functions described in this application, may be implemented as software code or computer readable instructions that may be executed by at least one processor using any suitable computer language such as, for example, Java, C++, or Perl using, for example, conventional or object-oriented techniques.

The software code may be stored as a series of instructions or commands on a non-transitory computer readable medium, such as a random access memory (RAM), a read only memory (ROM), a magnetic medium such as a hard-drive or a floppy disk, or an optical medium such as a CD-ROM. Any such computer readable medium may reside on or within a single computational apparatus and may be present on or within different computational apparatuses within a system or network.

It may be understood that the present invention as described above can be implemented in the form of control logic using computer software in a modular or integrated manner. Based on the disclosure and teachings provided herein, a person of ordinary skill in the art may know and appreciate other ways and/or methods to implement the present invention using hardware, software, or a combination of hardware and software.

The above description is illustrative and is not restrictive. Many variations of the invention will become apparent to those skilled in the art upon review of the disclosure. The scope of the invention should, therefore, be determined not with reference to the above description, but instead should be determined with reference to the pending claims along with their full scope or equivalents.

One or more features from any embodiment may be combined with one or more features of any other embodiment without departing from the scope of the invention. A recitation of “a”, “an” or “the” is intended to mean “one or more” unless specifically indicated to the contrary. Recitation of “and/or” is intended to represent the most inclusive sense of the term unless specifically indicated to the contrary.

One or more of the elements of the present system may be claimed as means for accomplishing a particular function. Where such means-plus-function elements are used to describe certain elements of a claimed system it will be understood by those of ordinary skill in the art having the present specification, figures and claims before them, that the corresponding structure is a general purpose computer, processor, or microprocessor (as the case may be) programmed to perform the particularly recited function using functionality found in any general purpose computer without special programming and/or by implementing one or more algorithms to achieve the recited functionality. As would be understood by those of ordinary skill in the art that algorithm may be expressed within this disclosure as a mathematical formula, a flow chart, a narrative, and/or in any other manner that provides sufficient structure for those of ordinary skill in the art to implement the recited process and its equivalents.

While the present disclosure may be embodied in many different forms, the drawings and discussion are presented with the understanding that the present disclosure is an exemplification of the principles of one or more inventions and is not intended to limit any one of the inventions to the embodiments illustrated.

The present disclosure provides a solution to the long-felt need described above. In particular, the systems and methods described herein may be configured for improving data transfer. Further advantages and modifications of the above described system and method will readily occur to those skilled in the art. The disclosure, in its broader aspects, is therefore not limited to the specific details, representative system and methods, and illustrative examples shown and described above. Various modifications and variations can be made to the above specification without departing from the scope or spirit of the present disclosure, and it is intended that the present disclosure covers all such modifications and variations provided they come within the scope of the following claims and their equivalents.

1. A computer-implemented method comprising:
selecting previously used merchants associated with a user based on past purchases of;
determining word vectors and dimensional indexes for each of the previously used merchants based on merchant data;
determining attributes for each of the previously used merchants using the word vectors and a semantic extraction algorithm, the attributes being subject to a correlation threshold;
determining word vectors and dimensional indexes for one or more recommended merchants;
determining a correlation value by correlating the determined attributes of the previously used merchants with attributes of the recommended merchants;
selecting threshold merchants from the recommended merchants, the threshold merchants having a determined correlation value above a threshold;
calculating a correlation of dimension indexes between the previously used merchants and the threshold merchants; and
providing a list of threshold merchants and highest ranked attributes as justification for a selection of merchants,
wherein the method is performed using one or more processors.

2. The method of claim 1, wherein the highest ranked attributes are conveyed to the user in a narrative using a narrative algorithm.

3. The method of claim 1, wherein the user is selected based on an electronic commerce payment device.

4. The method of claim 1, wherein the correlation threshold is set by an authority or determined by an algorithm.

5. The method of claim 1, wherein the recommended merchants include merchants which have been determined to be related to past merchants previously.

6. The method of claim 1, wherein the recommended merchants include merchants that have requested to be included as recommended merchants.

7. The method of claim 1, wherein determining word vectors further comprises executing a word vector algorithm against the recommended merchants.

8. The method of claim 1, wherein correlating the attributes of the previously used merchants and the recommended merchants comprises executing a correlation algorithm.

9. The method of claim 1 further comprising executing a correlation algorithm using the determined word vectors or dimension indexes.

10. A computer implemented method comprising:
selecting a user of an electronic commerce payment device;
determining word vectors for previous merchants that the user has already used;
determining attributes of the previous merchants from a semantic extraction algorithm, the attributes being subject to a correlation threshold;
selecting a plurality of merchants to be reviewed as recommended merchants;
determining word vectors for the recommended merchants;
determining a correlation value by correlating attributes between the previous merchants and the recommended merchants;
determining threshold merchants that have a correlation value above a threshold;
in response to determining threshold merchants, calculating a correlation of dimension index sets for the threshold merchants; and
providing a list of threshold merchants and highest ranked attributes as justification for selecting the threshold merchants,
wherein the method is performed using one or more processors.

11. The method of claim 10, wherein the highest ranked attributes are conveyed to the user in a narrative using a narrative algorithm.

12. The method of claim 10, wherein the electronic commerce payment device is a credit card.

13. The method of claim 10, wherein the correlation threshold is set by an authority.

14. The method of claim 10, wherein correlation threshold is determined by an algorithm.

15. The method of claim 10, wherein selecting merchants which will be reviewed as recommended merchants comprises selecting merchants which have been determined to be related to past merchants previously.

16. The method of claim 10, wherein selecting merchants which will be reviewed as recommended merchants comprises selecting merchants that have requested to be included as recommended merchants.

17. The method of claim 10, wherein determining word vectors further comprises executing a word vector algorithm against the recommended merchants.

18. The method of claim 10, wherein determining the correlation value between the previous merchants and the recommended merchants comprises executing a correlation algorithm.

19. The method of claim 18, wherein the correlation algorithm executes using the determined word vectors or dimension index sets.

20. A computer-implemented method comprising:
selecting previously used merchants associated with a user based on past purchases of the user;
determining word vectors for the previously used merchants based on merchant data;
determining attributes of the previously used merchants using the word vectors and a semantic extraction algorithm, the attributes being subject to a correlation threshold;
selecting one or more recommended merchants from a plurality of merchants, the one or more recommended merchants having attributes similar to the previously used merchants;
determining a correlation value by correlating the determined attributes of the previously used merchants with attributes of the recommended merchants;
selecting threshold merchants from the recommended merchants, the threshold merchants having a determined correlation value above a threshold;
determining a highest ranked attribute of the threshold merchants based on the attributes of the previously used merchants; and
providing a list of the threshold merchants and the highest ranked attribute,
wherein the method is performed using one or more processors.
